(19) United States
(12) Patent Application Publication
(10) Pub. No.: US 2022/0117429 A1
(43) Pub. Date: Apr. 21, 2022

(54) SECURE PACKAGE RECEPTACLE WITH REMOTE UNLOCKING

(71) Applicant: Delivery Pod Inc., Toronto (CA)

(72) Inventor: Mark MORRIS, York (CA)

(21) Appl. No.: 17/428,830

(22) PCT Filed: Feb. 5, 2020
(86) PCT No.: PCT/CA2020/050140

§ 371 Date: Aug. 5, 2021

Related U.S. Application Data
(60) Provisional application No. 62/897,653, filed on Sep. 9, 2019.
(60) Provisional application No. 62/801,459, filed on Feb. 5, 2019.

(51) Int. Cl. A47G 29/14

(52) U.S. Cl. CPC A47G 29/141; A47G 2200/08; A47G 2029/149; A47G 2029/144

(57) ABSTRACT

A secure package receptacle for receiving a package. The receptacle comprises a storage area to receive the package. The storage area adopts at least the following statuses: free, in which the storage area is accessible and ready to receive the package; locked, in which the storage area is inaccessible; and reset, in which the storage area is accessible and ready to retrieve the package. A change in status of the storage area is determined based the current status and on the sensing of the opening and closing of a lockable door providing or preventing access to the storage area.

### CROSS-REFERENCE TO RELATED APPLICATION

This application claims priority from U.S. provisional patent applications 62/897,653 filed Sep. 9, 2019 and 62/801,459 filed Feb. 5, 2019, the specifications of which are hereby incorporated herein by reference in their entireties.

### BACKGROUND

### (A) Field

The subject matter disclosed generally relates to security monitoring and in particular to a system and method that allows deliveries to be made at any time without the need for the presence of the recipient at the delivery site.

### (b) Related Prior Art

Increasingly, commerce involves delivering goods in packages to individual households from online purchases. This has led to the problem of packages being left for homeowners on the homeowner's property and stolen before the homeowner can pick them up—for example, if the homeowner is at work at the time of delivery.

Previous solutions have relied on codes being known to the delivery company, and/or have relied on the delivery company having the ability to enter the home of the person to whom the delivery is being made.

### SUMMARY

According to an embodiment, there is provided a system does not require complicated coordination in advance with delivery companies and/or the delivery company's clients (such as the online retailers). This system places control of the process in the hands of the homeowner. Further, this system is owned and under control of the homeowner, and thus can be used concurrently with a variety of delivery services.

According to an embodiment, there is provided a secure package receptacle for receiving a package, comprising: a storage area to receive the package, the storage area adopting at least the following statuses: free, in which the storage area is accessible and ready to receive the package; occupied, in which the storage area is inaccessible; and reset, in which the storage area is accessible and ready to retrieve the package; a door for the storage area; a lock mechanism associated to the door and adopting: a locked state in which the door is locked and prevents access to the storage area; and an unlocked state in which the door is unlocked and provides access to the storage area; a door sensor associated to the door for sensing opening and closing of the door; and a logic processing board connected to the lock mechanism and the door sensor, the logic processing board: maintains a registry of a current status of the storage area; receives, from the door sensor, signals indicative of the opening and closing of the door; updates the registry using the current status of the storage area based on the signals from the door sensor; and based on the updated current status in the registry, sends a command signal to the lock mechanism to control when the lock mechanism changes from a locked state to an unlocked state and vice versa.

According to an aspect, the receptacle further comprises a network communication module for communicating with an owner's device.

According to an aspect, the network communication module comprises one of an internet connection module; a wireless communication module; a Bluetooth module; and a cellular communication module.

According to an aspect, the receptacle further comprises indicators, wherein each indicator is associated to a respective one of the storage areas and communicates the current status of the storage areas.

According to an aspect, the receptacle further comprises a proximity sensor sensing presence and absence of a person about the secure package receptacle, wherein the proximity sensor transmits data to the logic processing board and the logic processing board switches between an idle state, when no presence is detected by the proximity sensor, and an active state, when a presence is detected by the proximity sensor, during which the indicators are activated to communicate the status of the associated storage areas.

According to an aspect, the proximity sensor comprises a Passive InfraRed (PIR) sensor.

According to an aspect, the indicators are light-emitting indicators comprising one or more lighting components emitting light of two colors.

According to an aspect, the receptacle further comprises a slot communicating with an upper one of the storage areas.

According to an aspect, the receptacle further comprises a slot sensor associated with the slot, with the logic processing board further adapted to update the registry associated with the upper one of the storage areas when the slot sensor detects one of an opening of an associated gate or passage of an envelope through the slot.

According to an aspect, the receptacle further comprises a proximity sensor sensing presence and absence of a person about the secure package receptacle and communicating proximity sensor readings to the logic processing board, with the logic processing board further adapted to update the registry associated with the upper one of the storage areas when the door sensors detects no door opening during a presence of the person about the secure package receptacle.

According to an aspect, the receptacle further comprises one of a camera and a microphone connected to the logic processing board.

According to an aspect, the receptacle further comprises a speaker connected to the logic processing board.

According to an aspect, the receptacle further comprises a physical key and a physical lock, wherein use of the physical key allows operating the physical providing to get access the storage areas.

According to an aspect, the receptacle further comprises a foot comprising an elongated member joined to a structure of the receptacle at two points thereby providing an opening to attach the receptacle.

According to an aspect, the receptacle further comprises a rear and a bottom, wherein at least one of the rear and the bottom comprises openings for fixtures.

According to an aspect, the receptacle further comprises a battery providing electrical power the logic processing board and the lock mechanism.

According to an aspect, the receptacle further comprises a power connector for connecting to a power source, whereby the power source powers the logic processing board and the lock mechanism.

According to an embodiment, there is provided a secure package receptacle for receiving packages, comprising: a structure defining storage areas to receive the packages, the storage areas capable of adopting at least the following statuses: free, in which the storage area is accessible and ready to receive the package; occupied, in which the storage area is inaccessible; and reset, in which the storage area is accessible and ready to retrieve the package; doors, each one of the doors for a respective one of the storage areas; lock mechanisms, wherein each lock mechanism is associated to a respective one of the doors, each one of the locks mechanisms capable of adopting: a locked state in which the respective door is locked and prevents access to the respective storage area; and an unlocked state in which the respective door is unlocked and provides access to the respective storage area; door sensors, wherein each door sensor is for sensing opening and closing of a corresponding one of the doors; and a logic processing board connected to the lock mechanisms and the door sensors, the logic processing board: maintains a registry of a current status of each of the storage areas; receives, from the door sensors, signals indicative of the opening and closing of each of the corresponding doors; updates the registry using the current status of the storage areas based on the signals from the door sensors; and based on the updated current status in the registry, sends a command signal to each of the lock mechanisms to control when each of the lock mechanisms changes from a locked state to an unlocked state and vice versa.

According to an embodiment, there is provided a secure package receptacle for receiving a package, comprising: a storage area for receiving the package, the storage area capable of adopting at least the following statuses: free, in which the storage area is accessible and ready to receive the package; occupied, in which the storage area is inaccessible; and reset, in which the storage area is accessible and ready to retrieve the package; a lockable door which, while unlocked, permits opening and closing thereby provides access to the storage area and, while locked, prevents access to the storage area; and a logic processing board in communication with the lockable door, the logic processing board updates the status of the storage area and controls when the lockable door is locked or unlocked based on a current status and on the opening and/or closing of the door.

According to an aspect, when the lockable door is opened and then closed while in the free status, the logic processing board updates the status from free to occupied and thereby automatically locks the lockable door.

According to an aspect, when the lockable door is opened and then closed while in the free status, the logic processing board updates the status from free to occupied and thereby automatically locks the lockable door.

According to an aspect, upon receiving a reset signal initiated by an owner's device while the lockable door is in the occupied status, the logic processing board updates the status from occupied to reset and thereby automatically unlocks the lockable door.

According to an aspect, when the lockable door is opened and then closed while in the reset status, the logic processing board updates the status from reset to free leaving the lockable door unlocked.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a front elevation view of a secure package receptacle with remote unlocking in accordance with an embodiment;

FIG. 2 is a side elevation view of the secure package receptacle with remote unlocking of FIG. 1;

FIG. 3 is a perspective view of the secure package receptacle with remote unlocking of FIGS. 1 and 2;

FIG. 4 is a front elevation view of a secure package receptacle with remote unlocking in accordance with another embodiment;

FIG. 5 is a left side elevation view of the secure package receptacle with remote unlocking of FIG. 4;

FIG. 6 is a right side elevation view of the secure package receptacle with remote unlocking of FIGS. 4 and 5;

FIG. 7 is a rear side elevation view of the secure package receptacle with remote unlocking of FIGS. 4 to 6;

FIG. 8 is a top side view of the secure package receptacle with remote unlocking of FIGS. 4 to 7;

FIG. 9 is a bottom side view of the secure package receptacle with remote unlocking of FIGS. 4 to 6;

FIG. 10 is a perspective view of the secure package receptacle with remote unlocking of FIGS. 4 to 9;

FIG. 11 is a perspective view of the secure package receptacle of FIGS. 4 to 10 in an idle state;

FIG. 12 is a perspective view of the secure package receptacle of FIGS. 4 to 11 with the top compartment in an unlocked state;

FIG. 13 is a perspective view of the secure package receptacle of FIGS. 4 to 12 with all compartments in a locked state;

FIG. 14 is a perspective view of the secure package receptacle of FIGS. 4 to 13 with the doors open;

FIG. 15 is a left isometric view of the secure package receptacle of FIGS. 4 to 14 with the doors closed;

FIG. 16 is a left isometric view of the secure package receptacle of FIGS. 4 to 15 with the doors open; and

FIG. 17 is a rear isometric view of the secure package receptacle of FIGS. 4 to 16;

FIG. 18 is a schematic of components of a secure package receptacle with remote unlocking in accordance with an embodiment; and

FIG. 19 is a flow chart illustrating exemplary steps of operation of the secure package receptacle with remote unlocking in accordance with an embodiment.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as,” or the like) provided herein, is intended merely to better illuminate the exemplary realizations and does not pose a limitation on the scope of the realizations. No language in the specification should be construed as indicating any unclaimed element as essential to the practice of the realizations.

In the following description, it is understood that terms such as “first”, “second”, “top”, “bottom”, “above”, “below”, and the like, are words of convenience and are not to be construed as limiting terms.

The terms “top”, “up”, “upper”, “bottom”, “lower”, “down”, “vertical”, “horizontal”, “interior” and “exterior” and the like are intended to be construed in their normal meaning in relation with normal installation of the system.

In realizations, there are disclosed components of secure package receptacle with remote unlocking.

It will be noted that throughout the appended drawings, like features are identified by like reference numerals.

### First System

The first system involves a receptacle 100 suitable for securely storing packages. The receptacle therefore incorporates or forms one or more storage areas. The receptacle 100 is made of a material that is not easily penetrated or cut. In a preferred embodiment, the storage areas are large enough to store several large packages. In one embodiment, the storage areas are of different sizes, and optionally one or more of the storage areas may be large enough to receive mail but not large enough to receive a sizable package.

In a preferred embodiment, the receptacle 100 is a vertical PTE plastic or metal box, balanced on four legs or two ski-like legs, where the legs have sufficient height to place the box above a reasonable amount of salt, snow, water, or mud that may accumulate beside or under the receptacle.

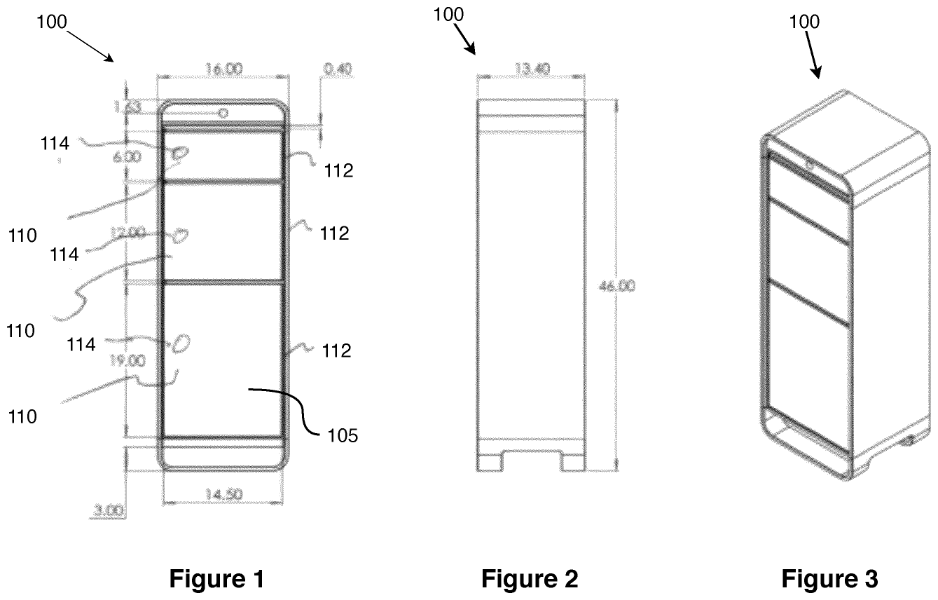

The receptacle height and dimensions according to an embodiment are illustrated in the attached FIGS. 1, 2 and 3. FIG. 1 is a front view. FIG. 2 is a side view. FIG. 3 is a perspective view. The units of the dimensions are in inches.

It is to be noted that the specific measurements of the dimensions are illustrative of one embodiment and may be greatly varied in other embodiments. It is also to be noted that the leg configuration may be different than depicted.

The receptacle 100 is constructed and configured to be securely attached or installed on a homeowner's property. In a preferred embodiment, the receptacle 100 has a handle, a hole or an eyelet (or a similar feature), not depicted on FIGS. 1 to 3, that allows the receptacle 100 to be secured to the homeowner's house, for example through the use of a bike lock or other form of lock, or in an alternative to being directly bolted to the homeowner's property.

It will also have bolt holes adapted to attach the receptacle 100 to a home if the owner of the receptacle 100 chooses to do so in place of the bike lock. Whether using some sort of lock or bolts, it is important that the structure to which the receptacle 100 is attached itself be solidly grounded and immovable.

According to an embodiment, the receptacle 100 has one point of entry and exit into each storage area 105 (aside from the possibility of the hole or eyelet opening into a storage area). In a preferred embodiment, the point of entry and exit is at the front of the receptacle. In an embodiment, the point of entry and exit is a lockable hatch or door. In one embodiment, illustrated in FIG. 1, each door 110 has hinges 112 and a handle 114. Other arrangements of hinges and handles may be used.

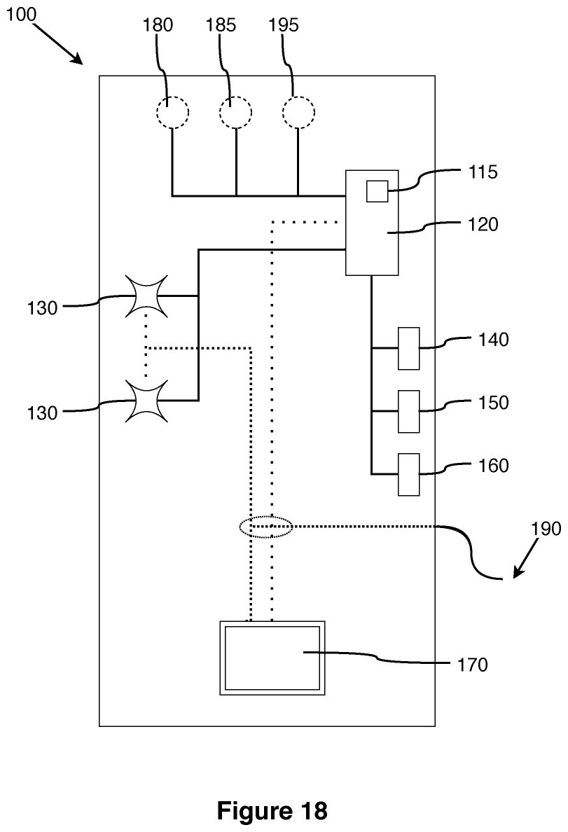

Referring additionally to FIG. 18, the receptacle 100 has associated therewith a network communication module 115 (e.g., an internet communication module, a WiFi chip (wireless connection module), a Bluetooth chip (Bluetooth module), a cellular network connection chip (cellular communication module), or any combination thereof), a logic processing board 120, and one motorized lock mechanism 130 for each storage area. The receptacle 100 further comprises a door sensor (illustrated as part of the motorized lock mechanism 130), a proximity sensor 140, a physical proximity switch 150, and a lighting system 160, preferably an LED lighting system comprising light-emitting indicators. The light emitting indicators may comprise one or more lighting components emitting light of two colors or more.

The proximity switch 150 is located on the outside or the inside of the receptacle 100, and has two settings A and B. When the proximity switch 150 is set to setting A, the proximity sensor 140 has a first distance to detect movement, and when the proximity switch 150 is set to setting B, the proximity sensor 140 has a second distance to detect movement. In one embodiment, setting A is labeled Home and setting B is labeled Store. In one embodiment, the first distance is three feet, and the second distance is five feet. According to an embodiment, the function of the proximity switch is implemented in software (i.e., there is no physical proximity switch).

According to an embodiment, there is also a physical “On/Off” switch (not illustrated) used by the owner to selectively provide electrical power to the receptacle 100. In another embodiment, electrical power to the receptacle 100 is controlled through a software application (i.e., an “app”) downloaded on a computing device (mobile or not) which communicates with the receptacle 100 via a network (wired or wireless).

The lockable hatches or doors 110 are initially left unlocked.

When a delivery person approaches the receptacle 100, the person's presence is detected by the proximity sensor 140, and activates the lighting system 160. Each storage area 105 has at least one light (not depicted on FIGS. 1 to 3) associated with it. In one embodiment, each storage area 105 is associated with one light to the left of the door 110 or hatch. Whether the lockable door 110 or hatch is locked is indicated by a color of the associated light indicator. In one embodiment, if the lockable hatch or door 110 is unlocked, the color will be green, and if it is locked, the color will be red. The delivery person will open an unlocked door 110 or hatch, place the package in the storage area 105, and will close the door 110 or hatch, which will automatically lock.

According to realizations, the lockable doors 110 comprise a lock mechanism and a position detecting mechanism (aka door sensor) associated with each of the doors 110. In one realization, detection of the door position is performed by a magnetic reed switch. Locking function of the lock mechanisms are performed by electro-mechanical switches.

According to a realization, the lock mechanisms comprises all the components that are required for both locking/unlocking the door and for detecting position/changes in position of the door.

According to a realization, the doors 110 are mounted to spring loaded hinges that ensure that the doors 110 remain closed when undergoing no external force such as a person opening the door for delivery or for retrieving a package.

In a preferred embodiment, a WiFi chip and a Bluetooth chip (both embodied in the network communication module 115), are configured with a connection to the Internet and software for addressing a logic processing board 120 which in turn is in communication with motorized lock mechanisms 130. Hence a distant or remote person, typically the homeowner, can receive a message whenever a lockable door 110 or hatch has been locked. This may be done by connecting the receptacle 100 to a home or office's WiFi network. In one embodiment, the homeowner will be notified of which specific lockable door 110 or hatch has been locked. The receptacle 100 will communicate with the homeowner either using a smartphone application, or a webpage accessed through a computer, or both.

The lock mechanisms can be unlocked by the homeowner using a smartphone app, or a webpage accessed through a computer, or both, and packages or mail removed from the associated storage area 105. The lock mechanisms may be unlocked individually, or may be unlocked all at the same time. While it is anticipated that the homeowner will typically be beside the receptacle 100 when unlocking the lockable doors 110 or hatches, the homeowner can unlock the lockable doors 110 or hatches remotely or at a distance.

The WiFi chip, Bluetooth chip, and logic processing board 120 are typically incorporated into the receptacle. However, the WiFi chip, Bluetooth chip, and logic processing board 120 may be one unit or separate units and may or may not be incorporated into the receptacle 100.

In a preferred embodiment, the distant person can remotely confirm that a lock mechanism 130 is locked or unlocked.

In a preferred embodiment, the lock mechanisms 130 can also be opened by a physical key (not depicted) or other physical methods, where the key is typically used by the homeowner, and allows the homeowner to access the storage area 105 without the use of the electronic unlocking technology (i.e., using a physical lock with a distinct keyhole entry, where each unit has a different key).

It should be understood that the distant or remote person means that the person is not adjacent to the receptacle 100. Distant or remote person would, for example, include a situation where the receptacle 100 is attached to a house and the distant or remote person is inside the house.

In a preferred embodiment, this first system will include a written notice notifying delivery persons of where to store packages and how to use this first system. This written notice can be integrated into the receptacle 100 or be separate from the receptacle 100, and can, for example, be communicated through pictograms.

The receptacle 100 is powered by a battery 170. In one embodiment, the receptacle 100 could also be powered by plugging a power connector of the receptacle 100 into an external power source 190. In another embodiment, the receptacle 100 is both powered by an external power source 190 and has a battery 170 to power the receptacle if the external power source fails.

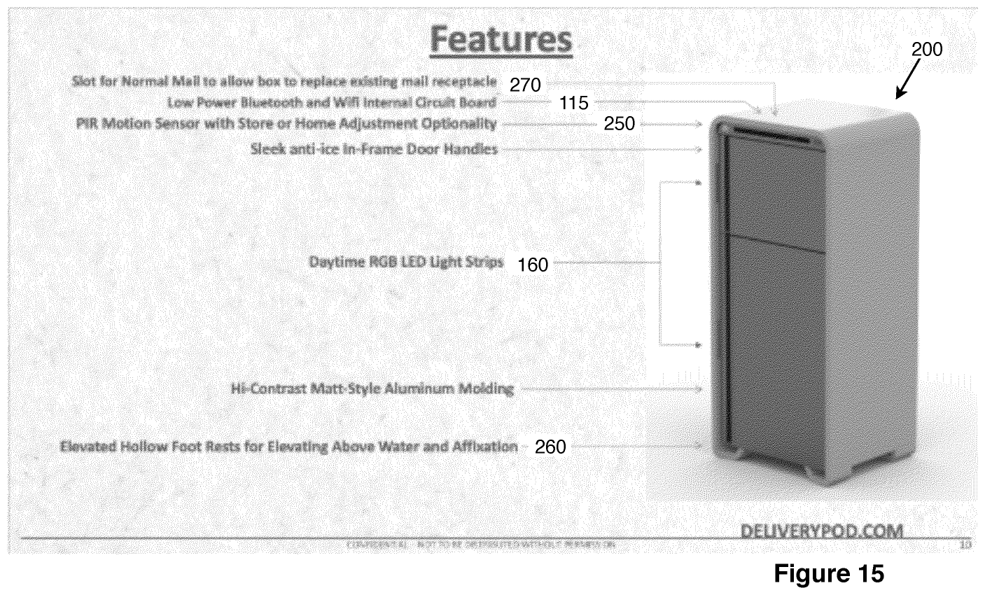

In a specific embodiment, there is provided a storage area 105 sized and positioned to receive mail (e.g., envelopes) through a slot 270 (FIG. 15) in the receptacle 200. Accordingly, storage area 105 and the envelopes left therein are inaccessible to others than the person that controls the receptacle 200. According to an embodiment, the lockable door 110 or hatch for this storage area 105 is always locked, except when the homeowner disengages the lock mechanism 130 either by a smartphone app or a computer web browser or by using a key. Such a receptacle 100 could act as a replacement for a traditional home mailbox.

In a realization, the slot 270 comprises a spring-mounted gate blocking the slot 270 when no external force operates on the gate.

According to realizations, a slot sensor (not shown) is mounted to the gate to detect displacement of the gate, or a slot sensor detecting passage of an envelope in the slot 270.

### Second System

The second system, still illustrated through FIGS. 1 to 3 and 18, involves a receptacle 100 suitable for securely storing packages. The receptacle 100 therefore incorporates or forms a storage area 105. The receptacle 100 should be made of a material that is not easily penetrated or cut. In a preferred embodiment, the storage area 105 is large enough to store several large packages.

In a preferred embodiment, the receptacle 100 is a vertical PTE plastic or metal box, balanced on four legs or two legs connected via a vertical bar at the ground level, where the legs have sufficient height to place the box above a reasonable amount of salt, snow, water, or mud that may accumulate beside or under the receptacle.

The receptacle 100 is constructed and configured to be securely attached or installed on a homeowner's property. In a preferred embodiment, the receptacle 100 has a handle, a hole or an eyelet (or a similar feature) that allows the receptacle to being secured to the homeowner's house, for example through use of a bike lock or other form of lock, or in an alternative to be directly bolted to the homeowner's property. Whether using some sort of lock or bolts, it is important that the structure to which the receptacle 100 is attached itself be solidly grounded and immovable.

According to an embodiment, the receptacle 100 has one point of entry and exit into the storage area 105 (aside from the possibility of the hole or eyelet opening into the storage area). In a preferred embodiment, the point of entry and exit is at the top of the receptacle 100. In an embodiment, the point of entry and exit is a lockable hatch.

The receptacle has associated therewith a camera 180 positioned to allow a view of persons attempting to place packages in the receptacle 100 at the point of entry and exit. In a preferred embodiment, the camera 180 uses a fisheye lens (not shown), or any lens that permits a wide view to be captured. In one embodiment, the camera 180 is built directly into the receptacle 100. In another embodiment, the camera 180 is separate from the receptacle 100.

The receptacle 100 has associated therewith a speaker 195 and microphone 185 that allow two-way communication between a person attempting to place objects in the receptacle 100 and a distant person. In one embodiment, the speaker 195 and microphone 185 are built directly into the receptacle 100. In another embodiment, the speaker 195 and microphone 185 are separate from the receptacle 100.

The receptacle 100 incorporates a lock mechanism 130 that can lock and unlock the point of entry and exit where the locking and unlocking can be controlled remotely by a distance person.

The lock mechanism 130 is incorporated into the receptacle 100. However, the camera 180, microphone 185 and speaker 195 may be one unit or separate units and may or may not be incorporated into the receptacle 100.

The lock mechanism 130, camera 180, microphone 185 and speaker 195 are configured, via the logic processing board 120 and the network communication module 115) with a connection to the Internet and software so that a distant or remote person, typically the homeowner, can:
(i) receive a notice (for example, on their mobile device or computer) that a delivery person wishes to place a package in the receptacle 100;
(ii) communicate with the delivery person via the camera 180, microphone 185 and speaker 195;
(iii) if the remote person wishes, remotely unlock the point of entry and exit.

If the remote person unlocks the point of entry and exit, the delivery person can place the package to be delivered in the receptacle 100. The receptacle 100, once locked, securely stores the package until it is picked up by the homeowner.

In a preferred embodiment, the point of exit and entry relocks automatically (i.e., without further steps by the delivery person) once the package has been placed in the storage area 105.

In a preferred embodiment, the distant person can remotely confirm that the exit and entry point is locked.

In a preferred embodiment, the lock mechanism 130 can also be opened by a key or other physical method, where the key is typically used by the homeowner, and allows the homeowner to access the storage area 105 without the use of the remote unlocking technology.

It should be understood that the distant or remote person means that the person is not adjacent to the receptacle 100. Distant or remote person would, for example, include a situation where the receptacle 100 is attached to a house and the distant or remote person is inside the house.

In a preferred embodiment, the second system will include a written notice notifying delivery persons of where to store packages and how to use the second system. This written notice can be integrated into the receptacle 100 or be separate from the receptacle 100, and can, for example, be communicated through pictograms.

The receptacle 100 (including the exit and entry point and lock mechanism), the camera 180, microphone 185 and speaker 195, and the software allowing for remote use of the camera 180, microphone 185, speaker 195 and lock mechanism 130, constitute a system (the second system) that allows the homeowner to remotely communicate with a delivery person and decide whether to unlock the receptacle 100 to allow access to the storage area, and to lock the receptacle 100 once the package has been placed in the storage area 105.

### Third System

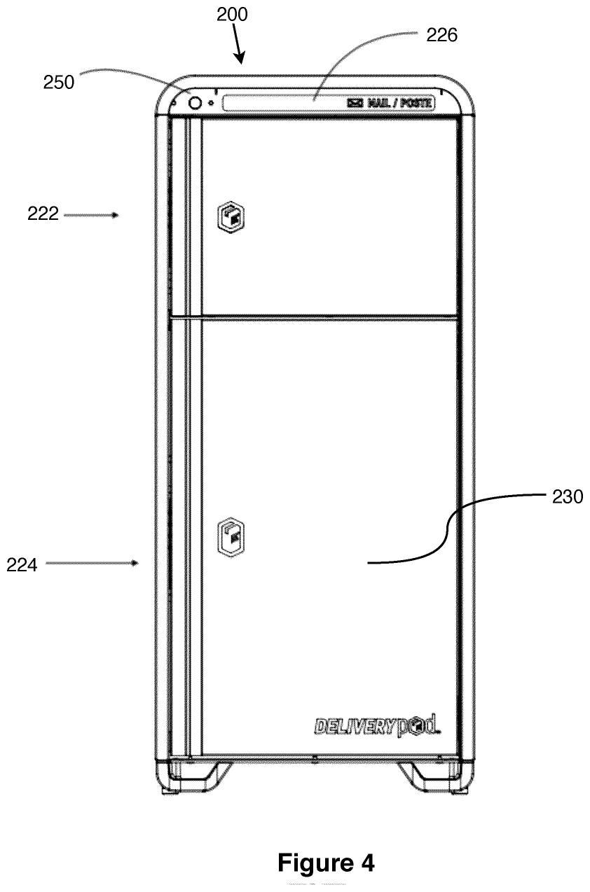

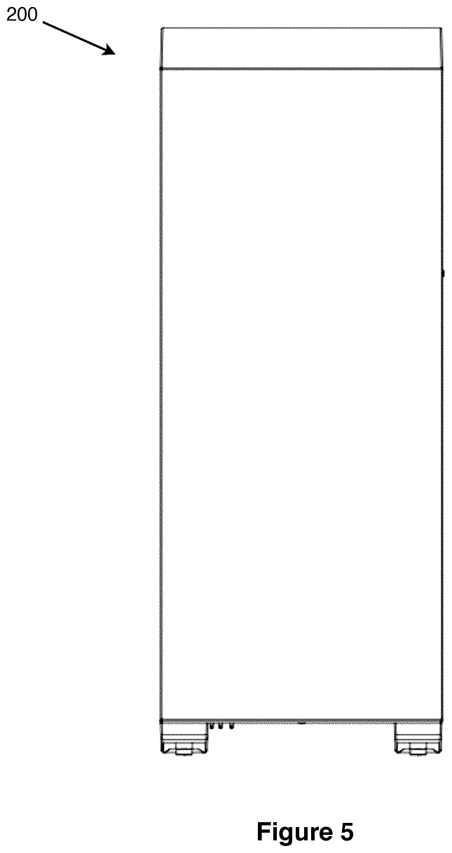

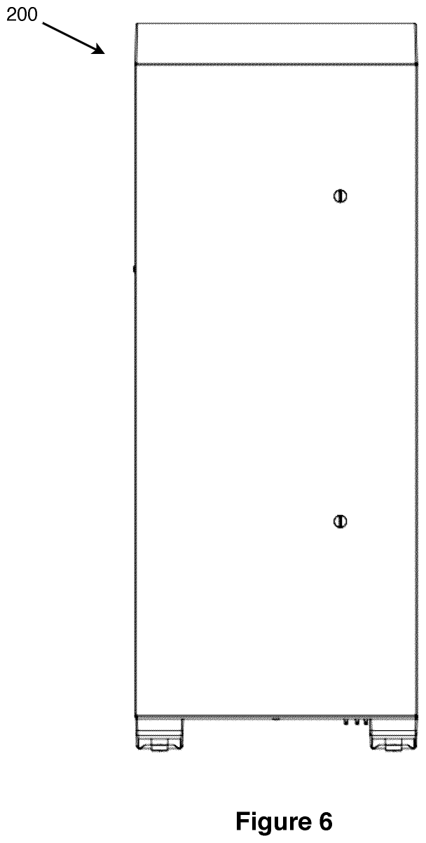

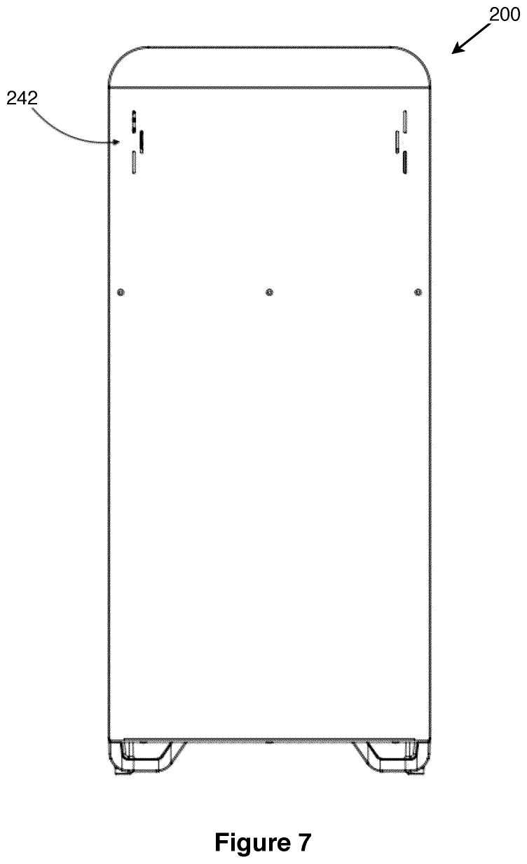

FIGS. 4 to 17 illustrate another embodiment of a receptacle 200 suitable for securely storing packages operating similarly to the embodiments of the described “First System” and “Second System”.

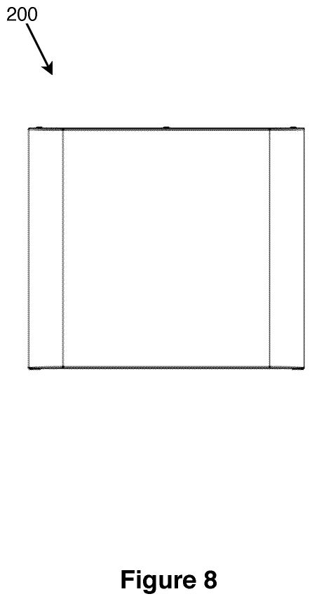

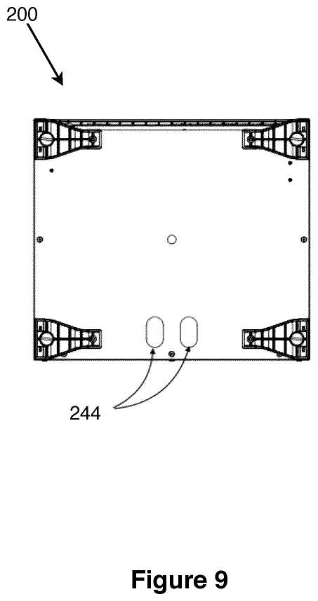

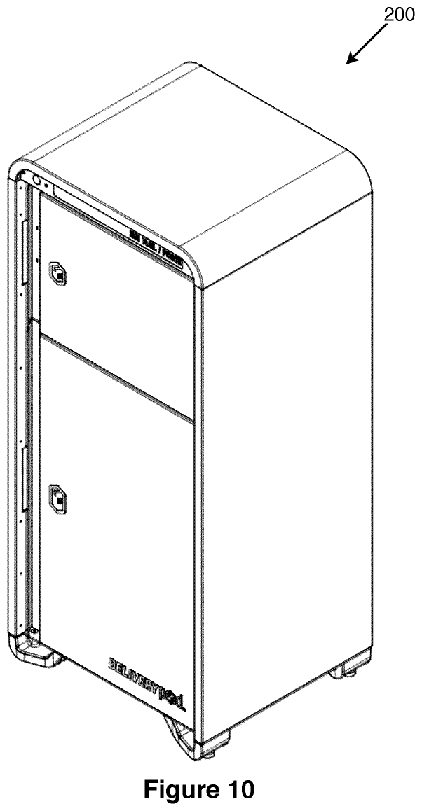

FIGS. 4 to 7 respectively illustrate a front side view, a left side view, a right side view and a rear side view of the receptacle 200. FIGS. 8 and 9 respectively illustrate a top side view and a bottom side view of the receptacle 200. FIG. 10 illustrates an isometric view of the receptacle 200 showing the front, the right side and the top of the receptacle 200.

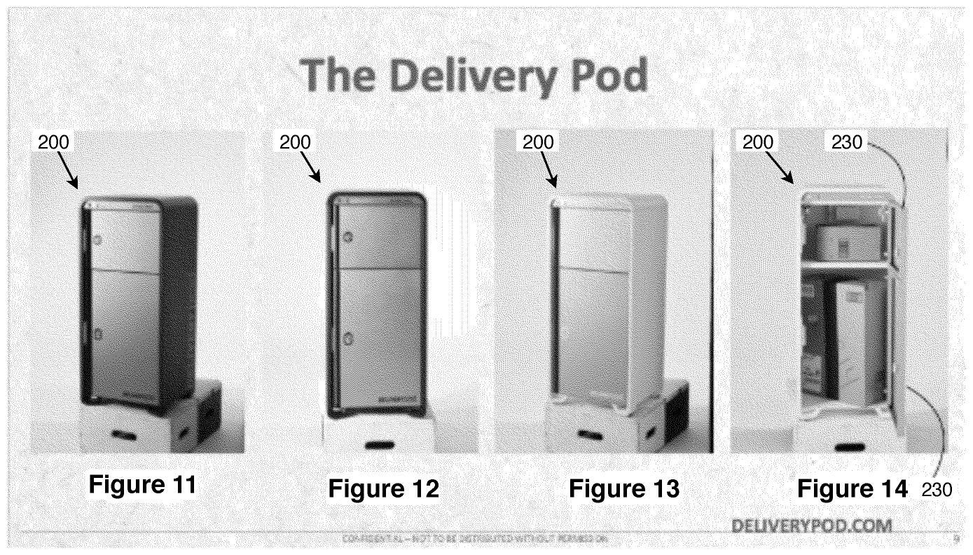

FIGS. 11 to 17 are photographs of embodiments of the receptacle 200 depicted on FIGS. 4 to 10. FIG. 11 depicts the receptacle 200 in an idle state with the doors unlocked and the light indicators in the “green” state. FIG. 12 depicts the receptacle 200 with the top compartment 222 in an unlocked state (light indicator is green) while the bottom compartment 224 is in a locked state (light indicator is red). FIG. 13 depicts the receptacle with compartments 222, 224 in a locked state (both light indicators are red). FIG. 14 depicts the receptacle with the doors 230 of compartments 222, 224 open (both light indicators are white to provide better lighting to the within the compartments 222, 224), providing access to the content of the compartments (for example, packages as depicted).

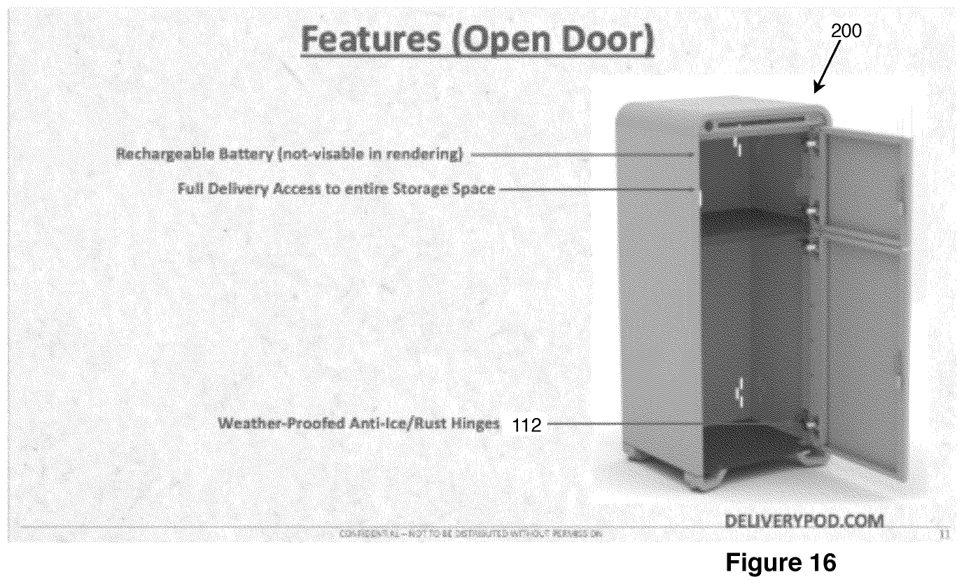

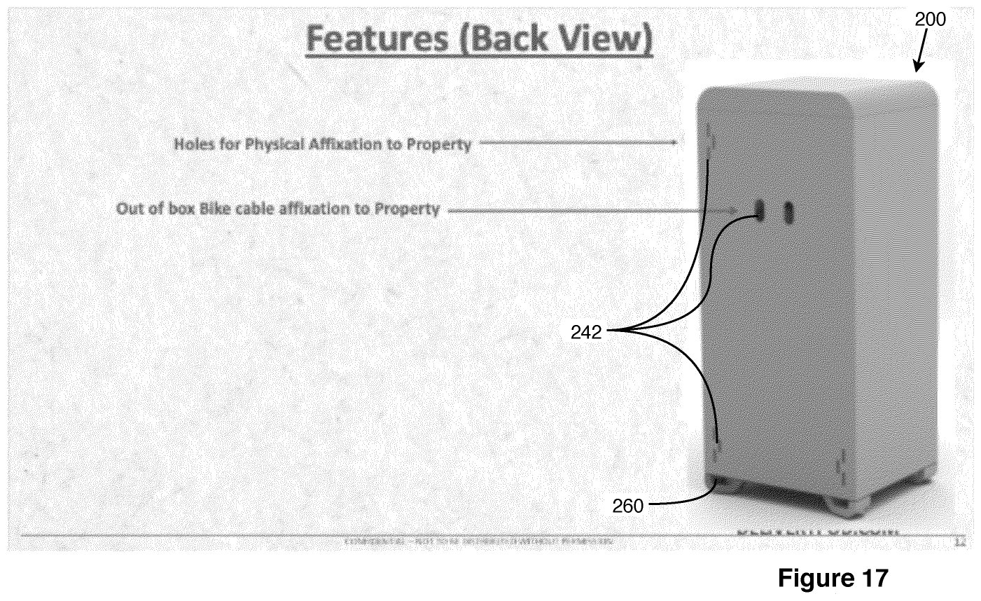

Accordingly, FIG. 15 is a photograph according to the same angle as the view of FIG. 10. FIG. 16 is a photograph of a left isometric view with the doors 230 open. FIG. 17 is a photograph of the rear of the receptacle 200 featuring openings 242 (aka slots) adapted to secure the receptacle 200 according to a particular embodiment.

It is worth noting in relation with FIGS. 4 to 10 that the receptacle 200 of the “Third System” features two compartments, one top compartment 222 and one bottom compartment 224, both individually openable. Above the top compartment 222, the receptacle comprises a horizontally elongated slot 226 adapted to receive envelopes and the like.

The receptacle 200 comprises manual key lock access (not identified on the figures) permitting to person using the key to access the content of the receptacle 200.

Regarding the structure of the receptacle 200, according to an embodiment (not depicted), the receptacle 200 is free of slots (such as the openings 242 presently located at the rear of the receptacle 200 and intended for securing the top portion of the receptacle 200 to a building or a permanent structure when present), with either the weight of the receptacle 200 being deemed appropriate or an alternative emplacement for securing the receptacle 200 such as the floor or the feet 260 of the receptacle 200 being used to secure it.

According to a realization, the feet 260 comprise elongated members mounted to the structure defining at least two mounting points with the portion between the two mounting points providing an opening for example a chain or a bike lock to pass therethrough to secure the receptacle 200.

According to an embodiment, the size and location of the slots 244 depicted on FIG. 9 are adapted for securing the receptacle 200 to a permanent structure. Typically, a steel cable or a chain is passed through the slots 244 and travels under the floor of the receptacle 200, thereby having the inter-slot portion of the floor within the loop of the cable or chain.

According to an embodiment, the receptacle 200 comprises a PIR (Passive InfraRed) sensor 250 (depicted on FIG. 4) adapted to detect movements in front of the receptacle 200. According to embodiments, the PIR sensor 250 is connected to a sub-system (not depicted per se), but in order to improve functions of the receptacle 200 (e.g., power management sub-system, security sub-system, etc.).

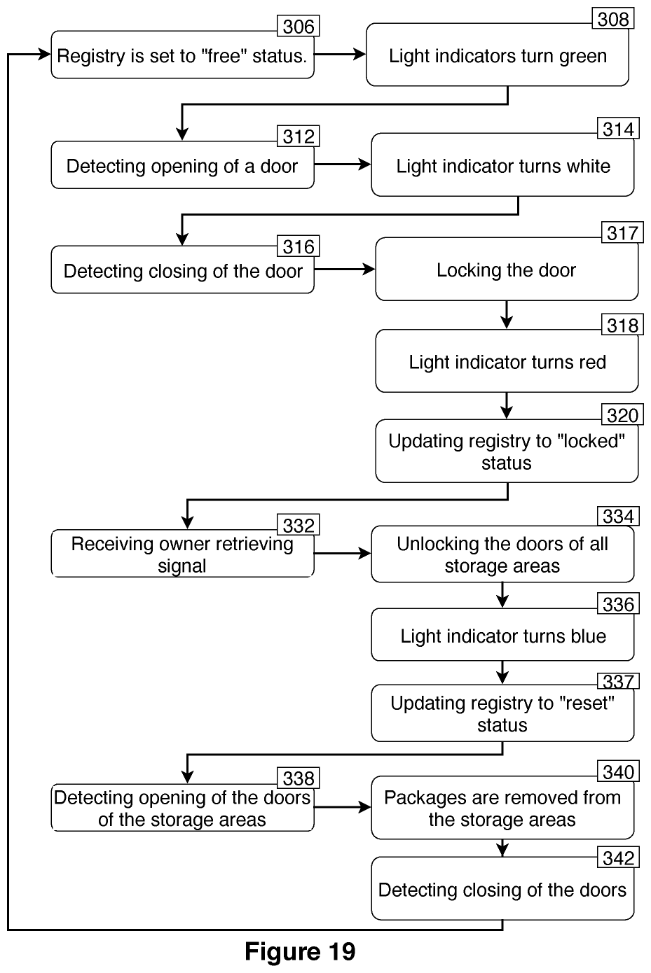

Referring now to FIG. 19, an exemplary method of operation of a secure package receptacle with remote unlocking comprises the following steps.

According to a realization, the light color is red for locked doors and green, blue or white for unlocked doors depending on whether the door is open or not and at what step in the process is the receptacle/are the statuses of the storage areas in the registry of the logic processing board. Further, the light indicators are made of strips of Light Emitting Diodes (LEDs) that operate in sequence in order to a) provide movement to get more attention from the person and b) use less power by having less LEDs lighting up at the same time.

The register keeps data on the “occupied” (locked or inaccessible), “free” (unlocked/accessible and ready to receive packages), and “reset” (unlocked/accessible and ready to retrieve packages) status of the storage areas based on the doors being opened and closed since the last reset of the registry; e.g., when the owner of the receptacle or an authorized person opened the doors to empty the storage areas.

The process starts at step 306 at which the registry of the logic processor board is set to “free” such that the storage areas are unlocked and ready to receive packages. At step 308, the light indicators are therefore set to green (as shown in FIG. 11).

At step 312, the door sensor detects that an unlocked door is opened, thus that a package can be placed in the associated storage area.

At step 314, the light indicator of the open door is turned white to provide more lighting of the storage area.

It should be noted that an indicator or indicators of other types may be contemplated. A simple window showing the interior of the storage area may be an indicator that there is a package therein and thus that the status of the door is closed and locked. If there is no package seen through the window, the status of the door may be assumed to be closed and locked. Another type of indicator may be electro-mechanical. An electromechanical indicator would change the position of a component which would reveal, by letters, color or simply the position of the component, the status of the storage area.

At step 316, the door sensor detects the closing of the door associated to the storage area and the lock locks the door automatically (step 317).

At step 318, the light indicator associated with the closed door is turned red to show that the door is now locked.

According to realization, a transition time is provided by the logic processing board, for example 15 seconds, during which the door remains unlocked and the light indicator provided a flashing red light to indicate that the door is about to be locked, therefore allowing the person to change their mind and reopen the door for instance to add a package.

At step 320, the logic processing board updates its registry to set the storage area to “occupied” (locked).

At step 332, the logic processing board receives the owner's retrieving signal, for example over a network (the Internet or a cellular network) or detects the owner's device through Bluetooth, triggering thereby a retrieving mode.

At step 334, the logic processing board unlocks all doors (or to a selected door according to another example).

At step 336, the light indicators are set to blue to communicate that the doors are unlocked and that the doors can be opened for retrieving packages. At step 337, the status of the storage area is set in the registry to “reset”.

At step 338, the doors are opened. According to an embodiment, the light indicators turn white. Otherwise the light indicators remain blue.

At step 340, packages are removed and the doors are closed. The door sensor thus detects the closing of the doors (step 342).

Not shown, the retrieving process may further use information from door open/close sensors to determine if and when storage areas have been emptied, and further if all storage areas having the registry occupancy data to “occupied” have been emptied. According to an embodiment, if the owner does not open the doors to retrieve the packages (i.e., the magnetic reed switches do not detect that the doors are opened then closed within a given period), the registry data will return to the occupied/locked status and the light indicators are reset to red.

The process returns to step 306 and the logic processing board resets the registry occupancy data, changing the data associated with all storage areas to “free” (unlocked) and the light indicator returns to green (step 308).

It should be noted that at any time during the process described above, the receptacle through its proximity sensor or PIR sensor is functional to detect the presence of someone close to the receptacle.

When the PIR sensor detects a presence, the receptacle lights up the light indicators of the lighting system based on the data of the registry of the logic processing board. This is useful for saving battery life. It is also useful for safety (to provide some lighting around the receptacle) and security purposes (to let potential thieves know that the receptacle is active and has detected their presence).

Further, additional light indicator settings and transit periods between “static” states may be configured without departing from the scope of the present method. Such configurations are intended to optimize the experience of both the user and the owner of the receptacle to ensure that the delivery process and the retrieving process are performed easily while keeping the security aspect of the present receptacle.

Not shown, the receptacle comprises processes to override failures of the proximity sensor or PIR sensor, such for instance a physical key as described before and/or a 2-level software unlocking process that allows to provide a command to the logic processing board to unlock the doors without the receptacle detecting if someone is close to the receptacle.

Further, according to realizations, the register is adapted to collect and communicate securely additional data on usage of the receptacle to the owner or an operation officer and/or operation registry (stored for example on the cloud). Examples of additional information comprise: a) timestamps of the deposition of the package in the receptacle and on the collection of the package from the receptacle, b) calculated data such as storage period calculated based on the two previous timestamps, c) usage data such as door opening timestamps and door closing timestamps, “detection-of-presence” timestamps, “no-more-detection-of-presence” timestamp, data collection from the camera, data collection from the microphone, unlocking method data, power management data, maintenance-related data, etc.

According to yet another embodiment, the receptacle is in regular communication, through a network connection, to a central (i.e., regional) controller (not shown). Therefore, when a user/owner is in fact in communication with the central controller (aka cloud-based server) through an app which in turn communicates with the receptacle. The central controller gathers usage information (macro-data) on all the receptacles connected thereto for analysis. Usage information includes, but is not limited to, number of deliveries, frequency of deliveries, storage areas of the receptacle which are used (indicative of the size of the package), time of day of the deliveries, time of day of the package retrievals, etc. This type of usage information can be used to create efficiencies for delivery services and product vendors.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A secure package receptacle for receiving a package, comprising:
a storage area to receive the package, the storage area adopting at least the following statuses: free, in which the storage area is accessible and ready to receive the package; occupied, in which the storage area is inaccessible; and reset, in which the storage area is accessible and ready to retrieve the package;
a door for the storage area;
a lock mechanism associated to the door and adopting: a locked state in which the door is locked and prevents access to the storage area; and an unlocked state in which the door is unlocked and provides access to the storage area;
a door sensor associated to the door for sensing opening and closing of the door; and
a logic processing board connected to the lock mechanism and the door sensor, the logic processing board:
maintains a registry of a current status of the storage area;
receives, from the door sensor, signals indicative of the opening and closing of the door;
updates the registry using the current status of the storage area based on the signals from the door sensor; and
based on the updated current status in the registry, sends a command signal to the lock mechanism to control when the lock mechanism changes from a locked state to an unlocked state and vice versa.

2. (canceled)

3. (canceled)

4. The secure package receptacle of claim 1, further comprising indicators, wherein each indicator is associated to a respective one of the storage areas and communicates the current status of the storage areas.

5. The secure package receptacle of claim 4, further comprising a proximity sensor sensing presence and absence of a person about the secure package receptacle, wherein the proximity sensor transmits data to the logic processing board and the logic processing board switches between an idle state, when no presence is detected by the proximity sensor, and an active state, when a presence is detected by the proximity sensor, during which the indicators are activated to communicate the status of the associated storage areas.

6. (canceled)

7. (canceled)

8. The secure package receptacle of claim 1, further comprising a slot communicating with an upper one of the storage areas.

9. The secure package receptacle of claim 8, further comprising a slot sensor associated with the slot, with the logic processing board further adapted to update the registry associated with the upper one of the storage areas when the slot sensor detects one of an opening of an associated gate or passage of an envelope through the slot.

10. The secure package receptacle of claim 8, further comprising a proximity sensor sensing presence and absence of a person about the secure package receptacle and communicating proximity sensor readings to the logic processing board, with the logic processing board further adapted to update the registry associated with the upper one of the storage areas when the door sensors detects no door opening during a presence of the person about the secure package receptacle.

11. (canceled)

12. (canceled)

13. The secure package receptacle of claim 1, further comprising a physical key and a physical lock, wherein use of the physical key allows operating the physical providing to get access the storage areas.

14. The secure package receptacle of claim 1, further comprising a foot comprising an elongated member joined to a structure of the receptacle at two points thereby providing an opening to attach the receptacle.

15. The secure package receptacle of claim 1, wherein the receptacle further comprises a rear and a bottom, wherein at least one of the rear and the bottom comprises openings for fixtures.

16. (canceled)

17. (canceled)

18. A secure package receptacle for receiving packages, comprising:
a structure defining storage areas to receive the packages, the storage areas capable of adopting at least the following statuses: free, in which the storage area is accessible and ready to receive the package; occupied, in which the storage area is inaccessible; and reset, in which the storage area is accessible and ready to retrieve the package;
doors, each one of the doors for a respective one of the storage areas;
lock mechanisms, wherein each lock mechanism is associated to a respective one of the doors, each one of the locks mechanisms capable of adopting: a locked state in which the respective door is locked and prevents access to the respective storage area; and an unlocked state in which the respective door is unlocked and provides access to the respective storage area;
door sensors, wherein each door sensor is for sensing opening and closing of a corresponding one of the doors; and
a logic processing board connected to the lock mechanisms and the door sensors, the logic processing board:
maintains a registry of a current status of each of the storage areas;
receives, from the door sensors, signals indicative of the opening and closing of each of the corresponding doors;
updates the registry using the current status of the storage areas based on the signals from the door sensors; and
based on the updated current status in the registry, sends a command signal to each of the lock mechanisms to control when each of the lock mechanisms changes from a locked state to an unlocked state and vice versa.

19. A secure package receptacle for receiving a package, comprising:
a storage area for receiving the package, the storage area capable of adopting at least the following statuses: free, in which the storage area is accessible and ready to receive the package; occupied, in which the storage area is inaccessible; and reset, in which the storage area is accessible and ready to retrieve the package;
a lockable door which, while unlocked, permits opening and closing thereby providing access to the storage area and, while locked, prevents access to the storage area; and
a logic processing board in communication with the lockable door, the logic processing board updates the status of the storage area and controls when the lockable door is locked or unlocked based on a current status and on the opening and/or closing of the door.

20. The secure package receptacle of claim 19, wherein, when the lockable door is opened and then closed while in the free status, the logic processing board updates the status from free to occupied and thereby automatically locks the lockable door.

21. The secure package receptacle of claim 19, wherein, upon receiving a reset signal initiated by an owner's device while the lockable door is in the occupied status, the logic processing board updates the status from occupied to reset and thereby automatically unlocks the lockable door.

22. The secure package receptacle of claim 19, wherein, when the lockable door is opened and then closed while in the reset status, the logic processing board updates the status from reset to free leaving the lockable door unlocked.

23. The secure package receptacle of claim 19, further comprising a network communication module for communicating with an owner's device.

24. The secure package receptacle of claim 23, wherein the network communication module comprises one of an internet connection module; a wireless communication module; a Bluetooth module; and a cellular communication module.

25. The secure package receptacle of claim 19, further comprising indicators, wherein each indicator is associated to a respective one of the storage areas and communicates the current status of the storage areas.

26. The secure package receptacle of claim 25, further comprising a proximity sensor sensing presence and absence of a person about the secure package receptacle, wherein the proximity sensor transmits data to the logic processing board and the logic processing board switches between an idle state, when no presence is detected by the proximity sensor, and an active state, when a presence is detected by the proximity sensor, during which the indicators are activated to communicate the status of the associated storage areas.

27. The secure package receptacle of claim 26, wherein the proximity sensor comprises a Passive InfraRed (PIR) sensor.

28. The secure package receptacle of claim 25, wherein the indicators are light-emitting indicators comprising one or more lighting components emitting light of two colors.
